(19) United States
(12) Patent Application Publication
(10) Pub. No.: US 2017/0046547 A1
(43) Pub. Date: Feb. 16, 2017

(54) VALIDATING A DECODED BARCODE AS AN EXPECTED BARCODE

(71) Applicant: SYMBOL TECHNOLOGIES, LLC, LINCOLNSHIRE, IL (US)

(72) Inventor: DANNY PACHECO, MISSISSAUGA (CA)

(21) Appl. No.: 14/826,525

(22) Filed: Aug. 14, 2015

(51) Int. Cl. G06K 7/10; H04W 4/00; G06K 7/14

(52) U.S. Cl. CPC G06K 7/10564; G06K 7/1413; H04W 4/008

(57) ABSTRACT

A method and data capture device including a transceiver operable to communication with a host server, a user interface, a database configured to store expected indicia received from the host server, a data capture engine operable to capture an indicia identity for decoding, and a processor operable to direct the data capture engine to capture an indicia for decoding. The processor is further operable to verify whether the decoded indicia identity matches one of the expected indicia identities in the database, wherein if the association is verified, the processor provides an indication on the user interface that the decoded indicia is valid as an expected indicia.

### BACKGROUND

Various electro-optical data capture devices have been developed for reading identification indicia for inventory purposes. For example, scanner systems have been developed for scanning electrical indicia such as an Electronic Article Surveillance (EAS) tag affixed to an item, a Radio Frequency Identification (RFID) tag embedded in the item, a Bluetooth™ Low Energy (BLE) tag attached to an item, an acoustic tag affixed to an item, and the like. Also, systems have been developed to read optical indicia on an item such as a laser or light emitting diode scanner reading a barcode printed on an item and imaging systems that use cameras to read a one-dimensional or a two-dimensional barcode printed on an item. A barcode is a coded pattern of graphical indicia comprised of a series of bars and spaces of varying widths, the bars and spaces having differing light reflecting characteristics. Data capture devices that read and decode barcodes employing a laser are typically referred to as laser-based barcode readers or scanners.

In the typical case of operating a such as a laser barcode scanner, activating a scan would notify a processor to turn on a laser and detector engine, operate a mirror to scan the laser beam over an area, operate the detector engine to receive any light reflections of the laser beam, and decode the reflections to determine if there is any barcode information within the reflections.

Imaging systems that read and decode barcodes employing Charge Coupled Device (CCD) or Complementary Metal Oxide Semiconductor (CMOS)-based imaging systems are typically referred to as imaging-based barcode readers or scanners. Imaging systems include CCD arrays, CMOS arrays, or other imaging pixel arrays having a plurality of photosensitive elements or pixels. In the case of a data capture device such as an imager, activating a scan typically would notify a processor to turn on an image detector engine, illuminate an area such that light reflected from a target barcode image is focused through a lens of the imaging system onto the pixel array, wherein an analog-to-digital converter digitizes output signals from the pixels of the pixel array to capture an image frame of the area, whereupon decoding circuitry of an imaging engine analyzes the digitized signals and attempts to determine if there is any barcode information within the image to decode.

An operator may use either data capture system to read an indicia of an item to be picked for example, wherein after capturing any barcode information the scanner processor will report the barcode information to a host server using a wireless local area network (LAN) or wireless wide area network (WAN), and receive information back from the server validating whether the decoded barcode is correct for that pick, whereupon the data capture system processor will deliver an annunciation to an operator indicating a successful pick. However, in some operator workflows, where every individual item being picked is scanned (i.e., the operator is directed to pick x number of items and scan each one), the number of these round trip communications with the host server is large, resulting in a large amount of communication overhead and operational latency time delays for receiving validation information from the host server.

Accordingly, there is a need for a technique to alleviate the above issues in communication overhead and operational latency associated with data capture devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of an apparatus, in accordance with some embodiments of the present invention.

FIG. 2 is a flowchart of a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method is described that mitigates issues with communication overhead and operational latency associated with data capture devices. Although the present invention is described in relation to a laser-based barcode scanner, it should be recognized that the present invention is also applicable to other data capture devices including imaging barcode systems, RFID systems, EAS systems, BLE systems, acoustic systems, and any electronic indicia reading system having communication overhead and operational latency issues.

The present invention accelerates validation performance by providing expected barcode information before any scan is actually performed. In this way, validation of barcode information could be performed within the data capture device without having to contact the host server after every scan. In this way, validation time would appear to a user to be nearly instantaneous, while saving the wireless communication overhead that would be used for picking many items. The present invention also has the potential for value added device services based on the validation of the data being performed in device (scanner). Analytics is a good example of a value added device service. The device can record the number of successfully validated scans verse failed validated scans and provide this statistic to the customer to measure productivity.

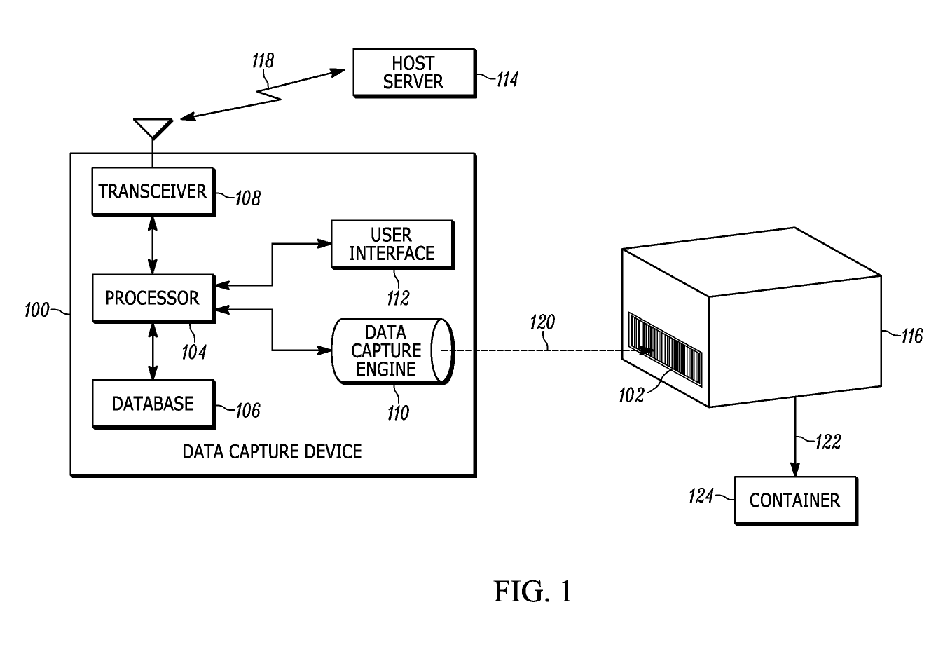

FIG. 1 is a block diagram depiction of a system that can use various wireless communication technologies and protocols for purposes of communications between a data capture device and a host server. In particular, the present invention provides a system with connectivity to a wireless local area network hereafter referred to as WLAN 100 and a wired or wireless wide area network hereafter referred to as WWAN 102. WLAN can be based on various protocols including but not limited to IEEE 802.11. WWAN can be based on various wired or wireless technologies such as cellular networks, Ethernet, etc. The communication between the data capture device and the host server can be accomplished via a wired connection such as an Ethernet connection, or wireless connection such as through access points of a local area network. Wireless systems can include local and wide-area networks, or other IEEE 802.11 wireless communication system. However, it should be recognized that the present invention is also applicable to many various wireless communication systems. For example, the description that follows can apply to one or more communication networks that are IEEE 802.xx-based, employing wireless technologies such as RF, IrDA (infrared), Bluetooth, ZigBee (and other variants of the IEEE 802.15 protocol), IEEE 802.11 (any variation), IEEE 802.16 (WiMAX or any other variation), IEEE 802.11u (Wi-Fi certified Passpoint™), IEEE 802.20, Direct Sequence Spread Spectrum; Frequency Hopping Spread Spectrum; cellular/wireless/cordless telecommunication protocols not limited to GSM, CDMA, TDMA, GPRS, EDGE, LTE, UMTS, etc.; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB, any of which can be modified to implement the embodiments of the present invention. In an exemplary embodiment, the portable data capture device and access point are preferably compliant with at least the IEEE 802.11 specification.

FIG. 1 shows various entities are adapted to support the inventive concepts of the embodiments of the present invention. Those skilled in the art will recognize that the drawings do not depict all of the equipment necessary for system to operate but only those system components and logical entities particularly relevant to the description of embodiments herein. For example, electro-optical systems, tracking devices, servers, and wireless network access points can all includes separate communication interfaces, transceivers, memories, and the like, all under control of a processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components.

FIG. 1 shows a typical physical profile of a data capture device 100 such as a portable barcode laser or imaging scanner according to the present invention. The scanner can be operable to capture and decoding 1D and 2D barcode indicia 102, including postal codes, Uniform Product Code, and Code 39 barcodes, images, and signatures. In one embodiment of the present invention, the data capture device 100 is a hand held portable scanner that can be carried and used by an operator or customer walking or riding through a store, warehouse, factory or plant, while scanning barcodes for stocking and inventory control purposes, for example. However, it should be recognized that the scanner of the present invention, to be explained below, may be advantageously used in connection with any type of automatic identification system including, but not limited to, barcode readers, signature imaging acquisition and identification systems, optical character recognition systems, fingerprint identification systems, and the like. It is the intent of the present invention to encompass all such automatic identification systems. Moreover, the present invention is also applicable to any data capture system having communication overhead and operational latency issues including RFID readers and tags, EAS readers and tags, BLE readers and tags, acoustic transducers and tags, etc.

Turning again to FIG. 1, a data capture device 100 such as a barcode imaging or laser scanner can include a data capture engine 110, user interface 122, transceiver 108, and database 106, all connected to and controlled by a processor 104. In normal operation, when activated by an operator (not shown) the processor triggers the data capture engine to read and decode a target barcode indicia 102 positioned on an item 116. A one-dimensional barcode comprises lines or different thickness with spaces therebetween, as is known in the art. Although a one-dimensional barcode is shown, two-dimensional barcodes could also be used.

In normal operation, upon activation of the data capture engine 110, the engine then activates an aiming pattern 120 from an internal illumination source, which is projected from the engine through a window using internal mirrors that are also controlled by the engine. The operator aligns the aiming pattern 120 with the target barcode indicia 102 to properly scan the entire barcode, whereupon the engine can capture and analyze reflections from the target barcode and run a decoding sequence to decode the information in the barcode. The engine will provide any successfully decoded indicia information to the processor 104.

The processor can then forward the decoded barcode information to the host server 114 for validation, inventory, and tracking purposes. The host server can validate that the supplied barcode information is valid and inform the processor 104 that the barcode information is from a valid correct barcode. The communications with the server can be accomplished via a wired connection (not shown) such as an Ethernet connection, or wireless connection 118 (shown) such as through access points of a local area network. The server can include its own processor, transceiver, memory and/or database, and user interface (all not shown), as is known in the art.

It is envisioned that the data capture device is a mobile terminal that can perform one of many different functions, such as scan a bar code with a laser-based scanner, take an image using an imaging module, set up a camera to take a picture, set up to send data over a wireless network, etc.

In a further embodiment of the invention, successfully decoding an indicia or receiving a validation signal from the host server includes providing a feedback notification to the user, such as an audio and/or visual feedback on the user interface 112. For example, audio feedback could be generated using an existing speaker on the data capture device wherein, after a successful decoding or validation of the indicia, the processor can send an audio signal to the speaker. In a further embodiment, the feedback to the operator (e.g. the sound from the speaker or visual feedback) can be different depending on whether a successful decode or validation of the indicia is indicated. Further, the user can select from a list of sounds and/or visual feedback that he or she would like the terminal to produce for different responses.

It is envisioned that the present invention can be used in those cases where validation of a barcode is needed when the barcode is scanned and decoded. In particular, the present invention is applicable to the use case where an operator is picking inventory when using an emulation application. The following is a typical picking workflow.

In typical warehouse use cases, all locations within the environment are labelled with a location barcode. The location barcode could contain an encoding of the actual location (for example, aisle-shelf column-shelf row) or it could be a random identifier that the host server has mapped to that location.

Accordingly, an operator can log onto an inventory management system and be assigned a pick list of items to gather by a host server. The host server then directs the operator to a correct pick location where the items to be picked are located.

The operator travels to the location. When they arrive at the location they confirm to the host server that they are in the correct location by scanning the location barcode at their given location.

The host server can download a table or map of barcode identities expected to be scanned at the pick location of the operator. The data capture device can store this information in its local database 106. The database 106 can include all inventoried items within the environment, or just those barcodes at the pick location, depending on operational preference, memory size, costs, etc.

Typically, in the prior art upon scanning an item's barcode to be picked by the operator, the data capture device first provides some sort of annunciator, alert or visual indication on the user interface 112 to signal a successful decode of the barcode, and then the decoded barcode identity is transmitted to the host server to validate if the barcode is the expected value, which can be transmitted back to the operator and indicated using some sort of annunciator, alert or visual indication if it is the expected barcode is found at that location. In other words, two alerts can result within a short time, which may be confusing to the operator. Or there may be a communication delay resulting in two separate alerts being provided to the operator, which may be even more confusing.

However, in accordance with the present invention, the data capture device can now check decoded barcode information against those in the database of barcodes expected to be found at that pick location in order to validate the decoded scan immediately. In this case only one annunciator, alert or visual indication can be provided to the operator on the user interface, indicating a successful decode and validation, which is simpler and less confusing. The barcode information could also be sent to the host server, but after the operator has received the proper alert, thereby saving time and keeping the operator working without waiting for a response from the host server.

Referring back to FIG. 1, in an optional embodiment, the operator can also scan a barcode on a container 124 that the picked items are put 122 into. The data capture device can use a different type of annunciator, alert or visual indication to signal successful decode of the container barcode. The decoded scan data of the container barcode is sent back to the host server to validate that the correct items are being put in the correct container at the correct location, whereupon the operator can be notified using some other sort of annunciator, alert or visual indication if it is the expected container. Alternatively, the database could include additional information of expected containers for that pick location, wherein only one annunciator, alert or visual indication can be provided to the operator on the user interface, indicating a successful decode and validation of the container as before, which is simpler and less confusing.

In the prior art, there are a minimum of two or three round trip communications with the host server for each item picked (one for the location, one for the item, and one for the container). In some workflows where every individual item picked is scanned (pick x number of items and scan each one), the number of these round trip communications is very high. Also, for every scan that is validated at the host, the expected barcode is known prior to the scan attempt. Therefore, the present invention can save a significant amount of time if the expected barcodes are sent to the data capture device using an application programming interface (API) and the data capture device validates that the decoded data is what is expected before or without validating with the host server.

In accordance with the present invention, there are also possibilities for unique feedback or behaviors when an unexpected barcode is decoded. In one embodiment, an unexpected barcode reading could be ignored and the scanner could continue to scan (where typically the scanner would stop scanning if a barcode is decoded successfully). In another embodiment, an unexpected barcode reading could have the data capture device use an annunciator to notify the user that the barcode being read is unexpected and it could continue to scan. In yet another embodiment, an unexpected barcode reading could have the data capture device signal to the user that the incorrect barcode was decoded using an annunciator and stop decoding. These scenarios are similar to the prior art, yet are performed quicker using the present invention since validation with the host server is not needed. Yet another use case is that any unexpected barcode can be discarded and the data capture device can find the closest expected barcode to the unexpected barcode and send it to the host server on behalf of the device.

In the present invention, the API could support exact matches as well as pattern matches. In addition, the API could support counts for use cases where the operator must scan all items in the pick list. This could provide unique feedback when the correct count of items is picked. For example, where the operator is required to pick three of the same item, the first two items could have successful pick feedback (e.g. green blink on the user interface) and the third item could have a successful total picks feedback (e.g. two quick green blinks on the user interface). In supporting this behavior the data capture device now knows when an incorrect item was scanned. This gives the system some insight into the workflow and the device could provide some unique functionality when this occurs. For example, when an incorrect barcode is read, the expected and actual barcode can be stored and later used to find patterns in errors (e.g. multiple operators always scanning the wrong location barcode for a particular location because a shelf is mislabeled).

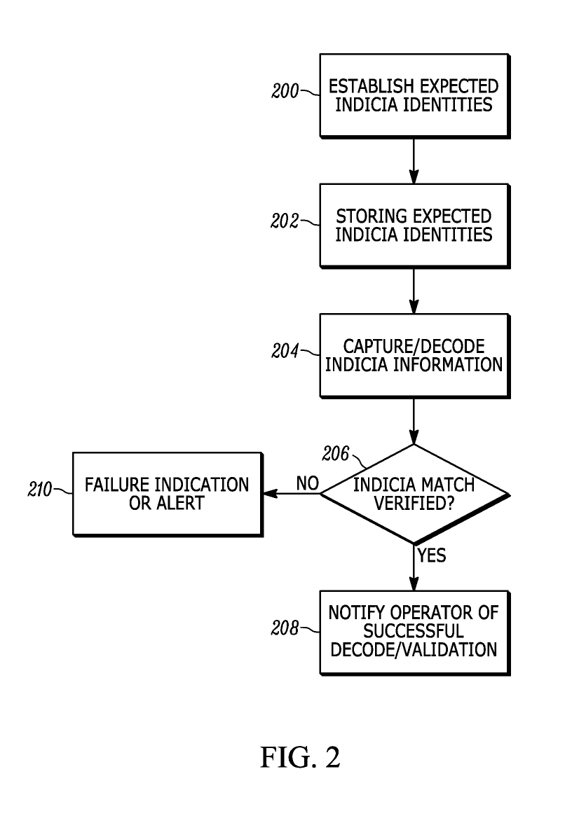

FIG. 2 illustrates a flowchart of a method for capturing indicia by a data capture device, in accordance with the present invention.

The method includes establishing 200 a pick location of the data capture device. This step can include a server establishing expected indicia identities and a data capture device receiving from the host server the expected indicia identities. Alternatively, the expected indicia identities can be pre-stored in the data capture device for the operator.

A next step includes storing 202 expected indicia identities, received from a host server in a local database of the data capture device. The database can also include container identity information used for storing items with their own indicia identities.

A next step includes capturing and decoding 204 indicia information of items. The indicia information can include indicia information on items and/or indicia information on a container used to contain items having their own indicia information that are scanned.

A next step includes verifying 206 whether the decoded indicia information matches one of the expected indicia identities stored in the local database.

If a match is verified, a next step includes providing 208 an indication or alert to an operator that the decoded indicia is valid as an expected indicia for that location, which indicia identity can be then reported to the host server. Otherwise, if a match is not verified, a next step includes sending 210 a failure indication or alert to the operator, without reporting the unverified indicia identity to the host server. Optionally, upon a failure, the decode can be ignored and the device continues as if no data was decoded, and the decoded data does not get sent back to the host server. Preferably, only one indication or alert is provided to the operator indicating that both a successful decode has occurred and a validation that an expected indicia has been decoded for that location. In addition, a different indication or alert can be provided to indicate invalid items. Also, a further different indication or alert can be provided for a correctly scanned container.

Advantageously, the present invention can accelerate validation performance by moving expected barcode information into a data capture device. In these cases, a barcode can be validated as being a correct barcode almost immediately, without the need to ask a remote host server for a confirming validation. In many use cases barcode reads are used to confirm that an operator did what was expected: they picked the correct item in the correct location. The present invention introduces an Application Program Interface that the host server can use to pass the expected barcode to the scanner. The scanner would use this information to display a validation success/failure indication to the user (instead of just a success/failure of a decode). If a failure occurs, the barcode does not need to be sent to the host server. With the present invention the expected barcode is known prior to the scan. In these use cases the scanner will give a success barcode decode indication and then pass the barcode back to the host server where it is compared to the expected barcode and a success/failure indication is given by the application. This can reduce the time it takes to give the user feedback on successfully accomplishing the task if the expected barcode is passed to the scanner. The present invention can also remove the extra, potentially confusing successful decode indicator.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A data capture device, the device comprising:
a transceiver operable to communication with a host server;
a user interface;
a database configured to store information, received from the host server, of indicia identities expected to be read a location and associated indicia information;
a data capture engine operable to capture indicia information; and
a processor coupled to the transceiver, user interface, database, and data capture engine, the processor operable direct the data capture engine to capture an indicia for decoding, the processor further operable to verify that the decoded indicia information matches one of the expected indicia identities stored in the database, wherein
if a match is verified, the processor provides an indication on the user interface that the decoded indicia is valid as an expected indicia.

2. The data capture device of claim 1, wherein if a match is not verified, the processor is further operable to provide a failure indication on the user interface.

3. The data capture device of claim 1, wherein if a match is not verified, the processor is further operable to: find a closest expected barcode to the captured indicia information, discard the captured indicia information, and send the closest expected barcode to the host server on behalf of the data capture device.

4. The data capture device of claim 1, wherein the processor is further operable to establish a pick location by directing the data capture engine to capture and decode a fixed location indicia encoded with location information.

5. The data capture device of claim 4, wherein the processor is further configured to receive the pick location information from the host server via the transceiver and receive from the host server the expected indicia identities for that pick location for storage in the database.

6. The data capture device of claim 1, wherein the processor also provides an indication on the user interface only when the captured indicia information has been successfully decoded and validated.

7. The data capture device of claim 1, wherein the processor and data capture engine are further operable to decode indicia of a container identity for holding items, and the processor is configured to further provide an indication on the user interface that the items are being placed in the correct container.

8. The data capture device of claim 7, wherein the processor also provides an indication on the user interface only when the captured indicia information has been successfully decoded and validated, and wherein the indication on the user interface for successfully decoding and validation is different from the indication on the user interface for placement in the correct container.

9. The data capture device of claim 1, wherein the data capture engine is a barcode imager and the indicia is a barcode.

10. The data capture device of claim 1, wherein the data capture engine is a laser bar code scanner and the indicia is a barcode.

11. The data capture device of claim 1, wherein the data capture engine is a Radio Frequency Identification reader and the indicia is a Radio Frequency Identification tag.

12. The data capture device of claim 1, wherein the data capture engine is a Bluetooth receiver and the indicia is a Bluetooth tag.

13. A bar code imager, comprising:
a transceiver operable to communication with a host server;
a user interface;
a database configured to store information, received from the host server, of expected barcode identities received from the host server;
a data capture engine operable to capture barcode identity; and
a processor coupled to the transceiver, user interface, database, and data capture engine, the processor operable to direct the data capture engine to capture location information from a fixed location barcode, send the location information to the host server using the transceiver, receive the expected barcodes from the host server for storage in the database, and direct the data capture engine to capture a barcode for decoding at the location, the processor further operable to verify that the decoded barcode identity is expected by determining whether the decoded barcode identity matches one of the expected barcode identities stored in the database, wherein
if the association is verified, the processor provides an indication on the user interface that the captured barcode has been successfully decoded and is valid as an expected barcode for that location.

14. A method for capturing indicia by a data capture device, the method comprising:
storing expected indicia identities, received from a host server in a local database of the data capture device;
capturing and decoding indicia information; and
verifying whether the decoded indicia information matches one of the expected indicia identities in the database, wherein
if the association is verified, providing an indication to an operator that the decoded indicia is valid as an expected indicia.

15. The method of claim 14, wherein if a match is not verified, further comprising providing a failure indication on the user interface.

16. The method of claim 14, wherein if a match is not verified, further comprising: finding a closest expected barcode to the captured indicia information, discarding the captured indicia information, and sending the closest expected barcode to the host server on behalf of the data capture device.

17. The method of claim 14, wherein providing includes providing an indication to the operator only when the captured indicia information has been successfully decoded and validated.

18. The method of claim 14, wherein capturing and decoding includes capturing and decoding indicia of a container identity for holding items, and wherein providing includes providing a different indication on the user interface that the items are being placed in the correct container.
